(19) United States
(12) Patent Application Publication
(10) Pub. No.: US 2026/0200595 A1
(43) Pub. Date: Jul. 16, 2026

(54) TOW BAR PROVIDED WITH A DEVICE FOR MECHANICAL MOVEMENT OF ITS RUNNING GEAR

(71) Applicant: LLEDO INDUSTRIES, Les Pennes-Mirabeau (FR)

(72) Inventor: Gérard Stéphane LLEDO, Les Pennes-Mirabeau (FR)

(21) Appl. No.: 19/152,114

(22) PCT Filed: Feb. 2, 2024
(86) PCT No.: PCT/EP2024/052672

§ 371 Date: Mar. 25, 2026

(30) Foreign Application Priority Data
Feb. 2, 2023 (FR) 2301011

(51) Int. Cl. B64F 1/223

(52) U.S. Cl. CPC B64F 1/224

(57) ABSTRACT

The invention relates to a tow bar which is provided with a device for mechanical movement of its running gear. One of the objectives of this invention is to provide a mechanism for manually locking/unlocking the running gear of an aircraft tow bar. To this end, the inventor proposes a mechanical indexing device comprising a control mechanism, a holding mechanism and a transmission mechanism for locking the various indexed positions of the running gear. In particular, unlocking and release of the running gear can be triggered manually by lifting the front end of the tow bar and by actuating the control mechanism.

### TECHNICAL FIELD

The invention relates to the field of tow bars for aircraft. Similar systems are known from document EP358474A1

### PRIOR ART

It is known that an aircraft tow bar is an indispensable tool for moving an aircraft on the ground. This bar generally comprises a main body and a running gear that enables the bar to be moved.

Typically, the running gear is designed to be locked and unlocked during the various stages of the towing operation. However, the locking and unlocking process can be complicated and laborious.

The current locking/unlocking mechanism may require the use of multiple tools or the application of excessive force, which can be difficult and time-consuming for the operator.

In addition, the current locking/unlocking mechanism may not be designed to be easily operated manually, which can make precise positioning of the running gear more difficult.

When the locking/unlocking mechanism is difficult to use, this can slow down the towing operation and may even make it more difficult to move the aircraft.

In practice, it is therefore necessary to have a locking/unlocking mechanism that is both effective and easy to use, in order to improve the efficiency of towing operations.

However, current solutions do not satisfactorily meet this need, hence the need for innovation in this area.

### SUMMARY OF THE INVENTION

The invention aims to, at least partially, meet this need.

In particular, the present application describes a tow bar which is provided with a device for mechanical movement of its running gear, as in claim 1.

The dependent claims describe specific embodiments of the present application.

### BRIEF DESCRIPTION OF THE DRAWINGS

Other features and advantages of the invention will be better understood on reading the following description with reference to the attached drawings, given for illustrative purposes and in no way limiting.

FIG. 1 shows the first implementation of the tow bar according to the invention.

FIG. 2 shows a second implementation of the tow bar according to the invention.

FIG. 3 shows a variant of the first implementation of the tow bar according to the invention.

FIG. 4 shows a variant of the second implementation of the tow bar according to the invention.

FIG. 5 shows a first front portion of the tow bar according to the invention.

FIG. 6 shows a second front portion of the tow bar according to the invention.

FIG. 7 shows a first intermediate portion of the tow bar according to the invention.

FIG. 9 shows a first rear portion of FIG. 4.

FIG. 10 shows a second rear portion of FIG. 4.

FIG. 11 shows a first attachment head according to the invention.

FIG. 12 shows a first variant of a second attachment head according to the invention.

FIG. 13 shows a second variant of a second attachment head according to the invention.

For the purposes of illustration, the figures are not necessarily to scale.

In addition, some drawings are presented in colour and/or transparency, as their representation in black and white is impossible. In particular, colour is necessary in some drawings to discern details that would be lost if they were presented in black and white.

### DESCRIPTION OF THE EMBODIMENTS

### Preliminary Remarks

In order not to obscure the description and distract the reader from understanding the teachings of the invention, explanations here will not go beyond what is considered necessary for understanding and appreciating the underlying concepts of the invention. Indeed, the embodiments illustrated in the description are, for the most part, composed of elements known to a person skilled in the art.

### Purpose of the Invention

An object of this invention is to provide a mechanism for manually locking/unlocking the running gear of an aircraft tow bar.

To this end, the inventor proposes a mechanical indexing device comprising a control mechanism, a holding mechanism and a transmission mechanism for locking the various indexed positions of the running gear.

In particular, unlocking and releasing the running gear can be manually initiated by raising the front end of the tow bar and operating the control mechanism.

### The Invention: a Tow Bar

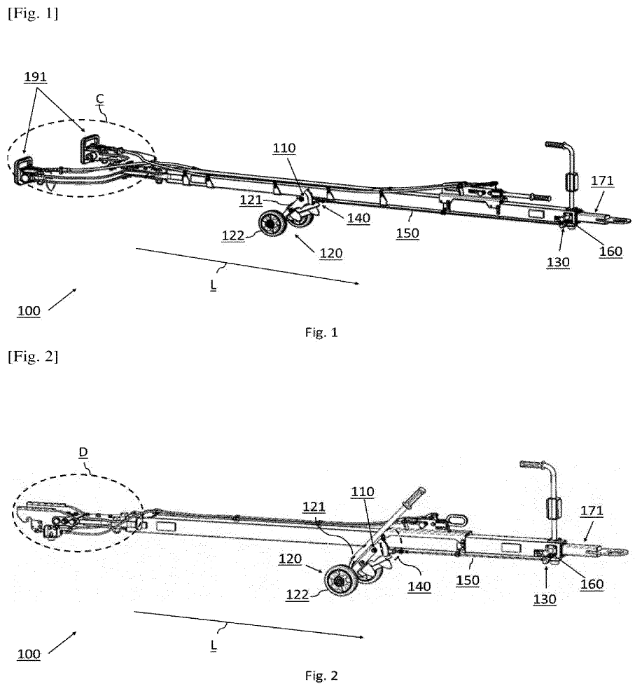

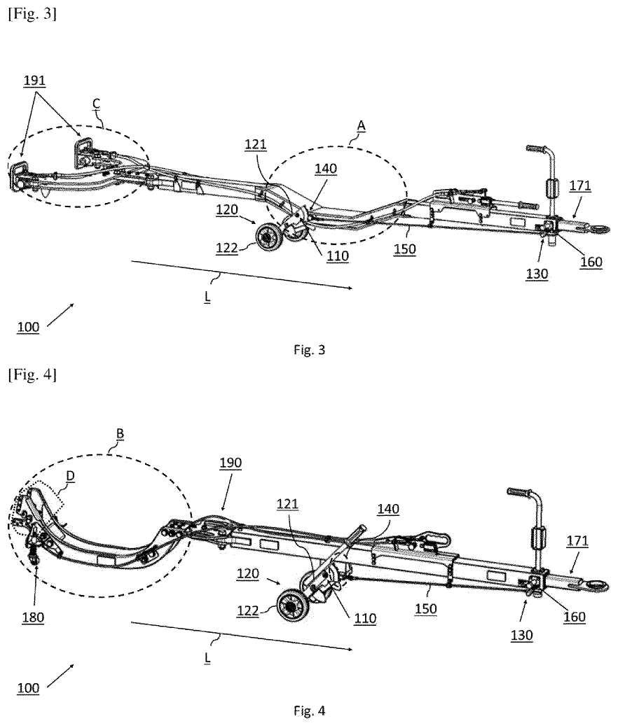

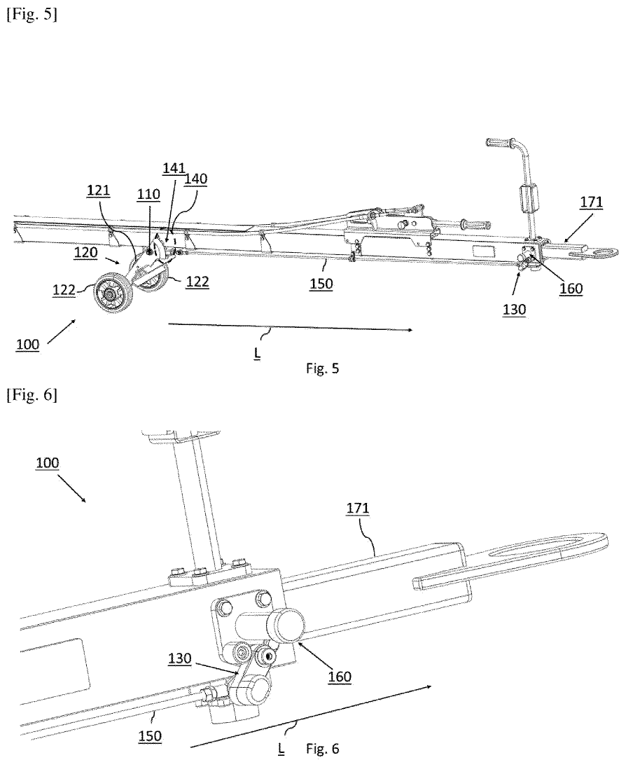

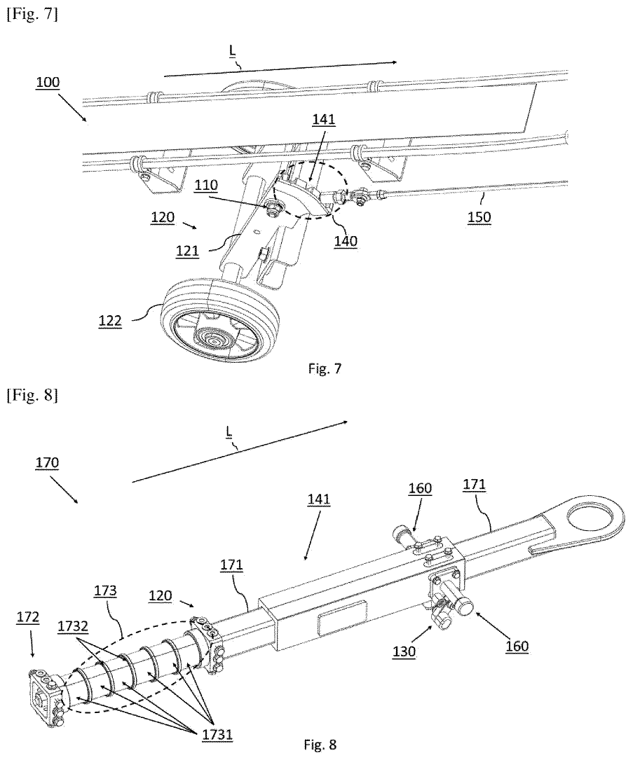

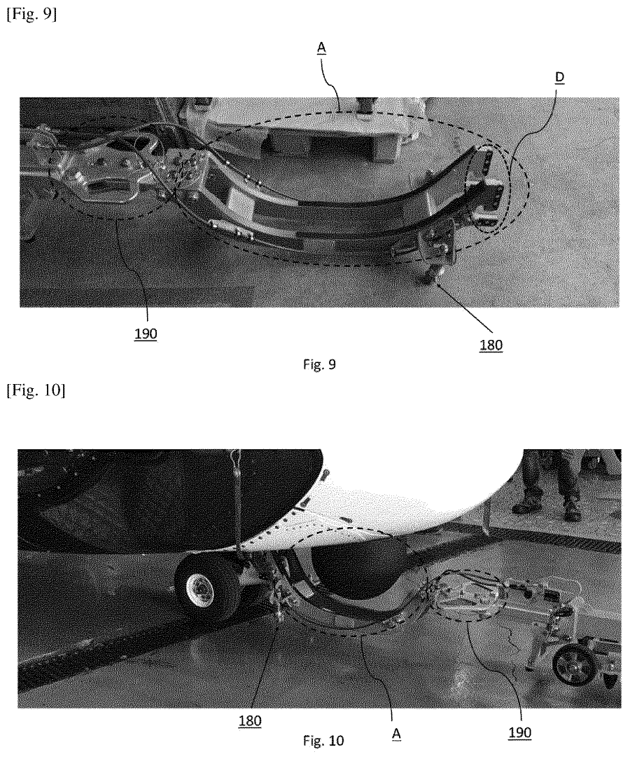

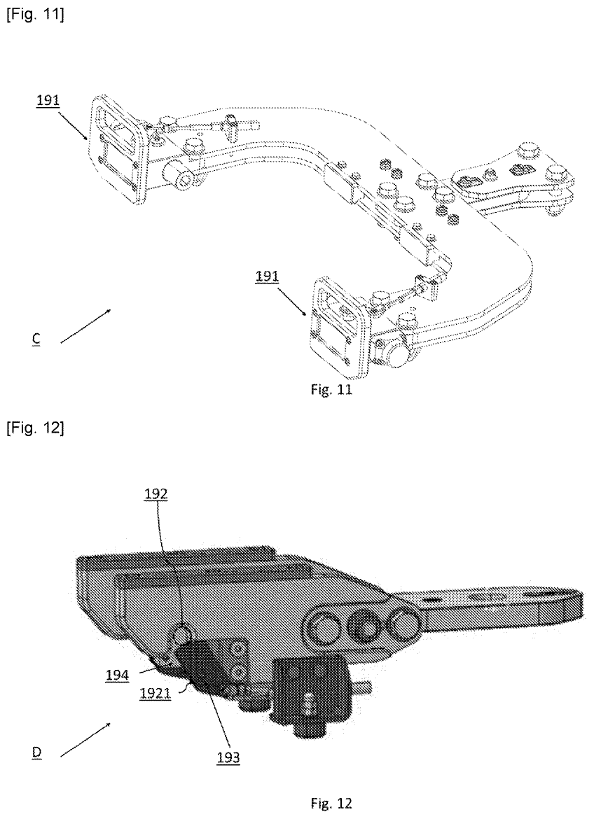

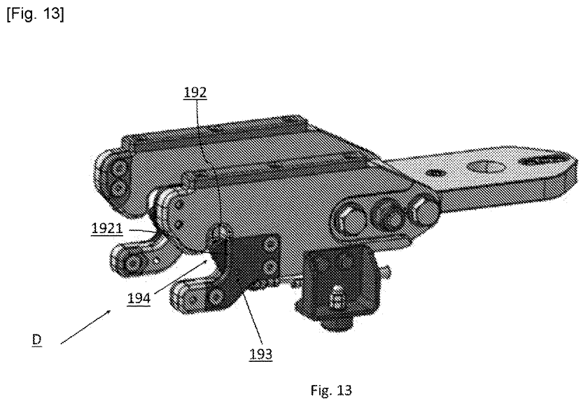

As illustrated in the set of FIGS. 1 to 13, the invention relates to a tow bar 100.

The term “tow bar” refers to a device used to tow or push an aircraft. This generally involves a robust bar that can be attached to the aircraft on the one hand, and to a towing vehicle on the other, allowing the aircraft to be moved over the ground.

The term “aircraft” refers to any vehicle capable of moving through the Earth's atmosphere. These may be aeroplanes, helicopters, airships or any other type of vehicle designed to navigate through the air.

In the invention, the tow bar 100 is specifically designed to connect to a nose landing gear or to engage with a nose wheel strut of an aircraft on the ground.

In other words, the tow bar 100 in the invention is specifically designed to couple with certain specific parts of an aircraft that is on the ground.

The term “nose landing gear” refers to the wheel system at the front of an aircraft This is an essential component of the aircraft, used for movement on the ground, landing and take-off. It may comprise one or more wheels, depending on the type and size of the aircraft.

The term “nose wheel strut” refers to the specific structure that connects the nose wheel of the landing gear to the rest of the aircraft. This is a key component of the landing gear, allowing wheel mobility and absorbing some of the forces generated during landing.

### Towing Bar Structure

In the invention, the tow bar 100 comprises a main body, a first pivot pin 110, a running gear 120 and a mechanical device for indexing the position of the running gear 120.

### Towing Bar Structure: a Main Body

In the invention, the main body extends longitudinally between a first end for attachment to the aircraft, referred to as the rear end, and a second end for attachment to a towing vehicle, referred to as the front end, which is opposite the rear end.

In other words, the main body of the tow bar 100 has an elongate structure that deploys in a longitudinal direction, L. This structure is designed with two separate attachment points; each located at one end of the tow bar 100.

Furthermore, the main body has a desired weight such as to ensure optimum stability during aircraft towing and pushing operations, while facilitating the manoeuvrability of the tow bar 100.

In other words, in the design of this tow bar 100 for aircraft, the weight of the main body is determined so as to optimise stability during aircraft towing and pushing operations. This particular weight contributes to both keeping the tow bar 100 stable when used to move the aircraft and to ensuring that the tow bar 100 can be manoeuvred with ease. For example, a tow bar 100 that is too light could be unstable when towing a heavy aircraft, while a tow bar 100 that is too heavy could be difficult to manoeuvre. Consequently, the main body weight is chosen to balance these two aspects.

### Towing Bar Structure: a First Pivot Pin 110

In the invention, the first pivot pin 110, which is integral with the main body, extends transversely through the main body,

The term “pivot pin” refers to a point or line about which an object can rotate or pivot. In particular, the pivot pin is a fixed element, integral with the main body of the bar, which extends through this main body in a direction perpendicular to its length. This positioning enables certain parts of the tow bar 100 to pivot or rotate around this pin.

The term “integral” generally means that two components or parts are designed to move together or are connected in such a way that the movement or position of one directly affects the other. In other words, if one component is said to be “integral” with another, this means that they are linked and act as a single unit in the mechanical system.

The term “through” is generally used to indicate that an object or element passes from one side to the other of another object or element. In other words, if a component is said to extend “through” another component, this means that it passes through the latter, penetrates it on one side and emerges on the other.

### Towing Bar Structure: a Running Gear

In the invention, the running gear 120 comprises a pair of arms 121 which are angularly adjustable relative to the main body and which are integrally connected to each other in parallel.

The term “angularly adjustable” refers to the ability to adjust or change the angle or orientation of something. In practice, the arms 121 of the running gear 120 are angularly adjustable in relation to the main body of the tow bar 100. This means that the angle between these arms 121 and the main body can be changed or adjusted as required, allowing precise adjustment of the position and orientation of the running gear 120.

The term “running gear” generally refers to the set of wheels on one of the tow bar 100 that allows it to move on the ground.

In practice, each arm 121 has a proximal portion and a distal portion.

In addition, each distal portion carries at least a first ground contact element 122.

The first ground contact element 122 is designed for moving the main body over the ground, when it is in contact with the ground,

In one example, the first ground contact element 122 is a wheel or a skid.

Furthermore, each proximal portion is coupled to the first pivot pin 110 so as to be able to rotate freely about it.

This enables the running gear 120 to occupy a succession of indexed positions.

The term “a succession of indexed positions” refers to a series of specific and identifiable positions that the running gear 120 can occupy. These positions are generally repeatable and can be referenced or “indexed” to enable precise identification. In this particular context, this means that the running gear 120 can occupy a variety of defined positions.

In practice, the indexed positions lie between a first extreme position, known as the folded-away position, and a second extreme position, known as the deployed position.

In the folded-away position, the ground contact elements are located at a minimum distance from the main body.

The term “minimum distance” refers to the smallest possible distance between the ground contact elements and the main body, when the running gear 120 is in the folded-away position.

In the deployed position, the ground contact elements are located at a maximum distance from the main body.

The term “maximum distance” refers to the greatest possible distance between the ground contact elements and the main body when the running gear 120 is in the deployed position.

In practice, in the deployed position, the running gear 120 is arranged along the main body so that the main body adopts a sloping or plunging configuration towards the front of the aircraft, with the front end away from the ground and the rear end close to the ground.

In other words, in the deployed position of the running gear 120, the tow bar 100 is arranged such that its main body is inclined towards the front of the aircraft. In other words, the front end of the tow bar 100 is higher with respect to the ground, while the rear end is closer to the ground. For example, when a tow bar 100 is used to tow an aircraft, the running gear 120 could be deployed so that the tow bar 100 adopts this sloping configuration. This could make towing the aircraft easier by positioning the front end of the tow bar 100 at a suitable height to connect to the aircraft, while keeping the rear end close to the ground for stability.

In a particular implementation of the running gear 120, the latter is designed to occupy at least a third position, known as the partially retracted position.

In the partially retracted position, the ground contact elements are located at a distance from the main body between the minimum distance and the maximum distance.

This allows the tow bar 100 to adapt to various ground and towing conditions.

In addition, in the event that the aircraft is heavily loaded, which could potentially lower the front of the aircraft, the tow bar 100 could adopt this partially retracted position.

This would allow the tow bar 100 to pass underneath the aircraft and attach onto it correctly, providing essential flexibility and adaptability in towing operations.

### Towing Bar Structure: a Mechanical Device for Indexing the Position of the Running Gear

In the invention, the mechanical device for indexing the position of the running gear 120 comprises a first mechanical control mechanism 130, a first mechanical holding mechanism 140 and a first mechanical control transmission mechanism 150.

### Structure of the Mechanical Device for Indexing the Position of the Running Gear: a First Mechanical Control Mechanism

In the invention, the first mechanical control mechanism 130 is designed to produce an exclusively mechanical force.

The term “an exclusively mechanical force” refers to a force that is produced and transmitted solely by mechanical means. It is a force that does not depend on the intervention of other forms of energy, such as electricity, magnetism or heat. This may involve the direct movement of physical objects, pressure, traction, or other forms of mechanical interaction.

In practice, the first mechanical control mechanism 130 is designed to, be movable between a first position and a second position, by direct transmission of at least one manual translational movement or one manual rotational movement.

The term “direct transmission” refers to the process by which motion or force is transmitted without the intervention of intermediate or indirect mechanisms. In other words, if a movement or force is transmitted by “direct transmission”, this means that it is transmitted immediately and without deviation or transformation by other mechanisms.

In one example, the first mechanical control mechanism 130 is a lever or push button.

In one particular implementation of the invention, the tow bar 100 further comprises, at least one fixed handle 160 which is disposed on the main body in the immediate vicinity of the first mechanical control mechanism 130.

The term “immediate vicinity” refers to an area very close to or adjacent to a specific reference point. In this case, it involves an area which is very close to or directly adjacent to the first mechanical control mechanism 130 on which the fixed handle 160 is arranged.

In practice, the fixed handle 160 is designed to be gripped by at least a part of an operator's hand, so as to enable the operator to exert, with at least one finger, a supporting force when actuating the first mechanical control mechanism 130.

The term “a supporting force” refers to the force that is exerted by the operator on the fixed handle 160 for the purpose of actuating the first mechanical control mechanism 130. In practice, this supporting force can help to trigger, control or adjust the operation of the first mechanical control mechanism 130.

For example, if the first control mechanism is a lever, the operator could grip the fixed handle 160 and push or pull the lever with one or more fingers.

In another example, if the first control mechanism is a push button, the operator could grip the fixed handle 160 and press the button with one or more fingers.

Thus, the presence of the fixed handle 160 in the immediate proximity of the first control mechanism facilitates the actuation of the latter by the operator.

### Structure of the Mechanical Device for Indexing the position of the running gear: a first mechanical holding mechanism

In the invention, the first mechanical holding mechanism 140 comprises a first elastic return device which is designed to return the first mechanical holding mechanism 140 to the various indexed positions.

The term “elastic return device” refers to a mechanical component that uses an elastic force, for example provided by a spring, to return another mechanism to its original position or to a series of predefined positions, also known as indexed positions.

For example, if the first holding mechanism is a lever that can be moved into various positions to perform various functions, the elastic return device would be able to return the lever to these predefined positions after it has been moved.

Thus, the elastic return device ensures a precise and reliable return of the first holding mechanism to its indexed positions.

In practice, the first mechanical holding mechanism 140 is designed to block the various indexed positions, when subjected to the effect of the weight of the main body, so that the arms 121 cannot rotate freely about the first pivot pin 110.

In practice, this means that the first mechanical holding mechanism 140 on an aircraft tow bar 100 is designed to stabilise the position of the arms 121 of the tow bar 100.

When subjected to the effect of the weight of the main body, the first mechanical holding mechanism 140 blocks the arms 121 in various indexed positions, thus preventing their free rotation about the first pivot pin 110.

For example, if the arms 121 of the tow bar 100 are positioned to tow an aircraft, the weight of the main body of the tow bar 100 could attempt to rotate them.

However, due to the first mechanical holding mechanism 140, the arms 121 will remain in their indexed position and will not rotate freely, thus ensuring stable and safe control of the aircraft during towing.

In a particular implementation, the first mechanical holding mechanism 140 comprises an indexing finger and a notching 141 that is designed to cooperate with the indexing finger.

The term “indexing finger” refers to an element that is designed to fit into another element, such as a notching 141, to maintain a specific position.

The term “notching” refers to a set of notches or depressions that are designed to receive the indexing finger.

The term “co-operate” refers to the functional interaction between two elements, in this case, an indexing finger and a notching 141. These two elements are designed to work together, or “cooperate”, to achieve a certain function. In particular, the indexing finger and the notching 141 are designed so that they engage with one another to ensure the precise positioning of the first mechanical holding mechanism 140.

In this particular implementation, the indexed positions follow each other discretely in succession.

The term “discretely” refers to a change or progression that occurs in distinct steps or at distinct intervals rather than continuously. In this particular implementation, this means that the indexed positions follow each other in distinct steps.

In an example of this particular implementation, the notching 141 is formed on the surface of the periphery of at least one of the arms 121.

The term “at the surface of the periphery” refers not only to the outer area or to the edge of a specific object, but also to a certain depth below the surface. In this particular exemplary implementation, this means that the notching 141 is machined or obtained in the mass of the material itself, to a certain depth from the outer surface or edge of at least one of the arms 121 of the running gear. Technically, a notching 141 “at the surface” therefore describes a notching 141 that is integral with the material over a certain depth from the surface.

In other words, the notching 141 is incorporated into the structure of the periphery of at least one of the arms 121. When it is said that the notching 141 is “at the surface of the periphery”, this means that the notching 141 is not simply attached to the outer surface or edge of the arm 121, but is machined or obtained in the material of the arm 121 itself, over a certain depth from the outer surface.

For example, if one of the arms 121 of the tow bar 100 is made of steel, the notching 141 would be machined directly into the steel to a certain depth from the surface of the arm 121.

Thus, the notching 141 is in fact an integral part of the structure of the arm 121, which contributes to its strength and durability.

### Structure of the Mechanical Device for Indexing the position of the running gear: a first mechanical control transmission mechanism

In the invention, the first mechanical control transmission mechanism 150 is designed to kinematically connect the first mechanical control mechanism 130 and the first mechanical holding mechanism 140.

The term “kinematically” refers to the way in which motion is transmitted or connected between two or more components. In this particular context, this means that the first mechanical control transmission mechanism 150 is designed to connect the movement between the first mechanical control mechanism 130 and the first mechanical holding mechanism 140.,

In other words, when the first control mechanism is activated, this causes a corresponding movement in the first holding mechanism.

For example, if the first control mechanism is a lever that is pushed forward, the first control transmission mechanism transmits this movement to the first holding mechanism, causing it to move in the same way.

In an exemplary embodiment of the first control transmission mechanism, the latter is selected from a series of cables, rods, connecting rods, a gear train or any other mechanism capable of transmitting movement between the first control mechanism and the first holding mechanism.

### Operation of the Mechanical Device for Indexing the Position of the Running Gear

In the invention, the mechanical indexing device is designed to respond to manual raising of the front end of the main body, relative to the ground.

The term “manual raising” refers to the action of raising or lifting an object using human strength, without the use of machinery or other aids.

This raising allows the first mechanical holding mechanism 140 to be at least partially relieved of the effect of the weight of the main body.

In other words, this manual raising can reduce the pressure exerted by the weight of the main body on the first mechanical holding mechanism 140.

Subsequently, the actuation of the first mechanical control mechanism 130 enables the exclusively mechanical force to be transmitted to release the first mechanical holding mechanism 140.

In this way, the first mechanical holding mechanism 140 can be unblocked, allowing the arms 121 to rotate freely about the first pivot pin 110.

### First Embodiment of the Invention: a Shock Absorbing Drawbar

In a first embodiment of the invention, a portion of the main body, referred to as the front portion, comprises the front end.

The front portion has a cross-section that is substantially square or rectangular.

The term “cross-section” refers to a view or section of an object along a plane perpendicular to its principal axis.

In addition, all or part of the front portion is hollow and defines an internal volume. The internal volume is designed to accommodate, at least in part, a shock absorbing drawbar assembly 170.

The shock absorbing drawbar assembly 170 comprises a drawbar 171, a fixed stop 172 and a damping device 173.

The damping device 173 is integral with the drawbar 171 in a coaxial manner.

The term “in a coaxial manner” refers to an arrangement where two or more objects share a common axis. In this particular context, this means that the damping device 173 is aligned with the drawbar 171 so that they share the same axis.

The damping device 173 is interposed between the tow bar 171 and the fixed stop 172.

The term “interposed” refers to an object or an element that is placed or positioned between two other objects or elements. In this particular context, this means that the damping device 173 is placed or positioned between the drawbar 171 and the fixed stop 172.

The function of the damping device 173 is to allow horizontal travel, thereby damping dynamic stresses.

The term “horizontal travel” refers to movement or oscillation in a direction that is lateral or parallel to the horizon. In this particular context, this means that the damping device 173 allows lateral movement to absorb shocks or applied forces.

The term “dynamic stresses” refers to variable forces and movements acting on an object or system. These include vibrations, which are rapid oscillations of an object around an equilibrium position, load peaks, which are sudden increases in force, and jolts, which are sudden, rapid movements. In this particular context, this means that the damping device 173 is designed to absorb these dynamic stresses.

In a particular implementation of the first embodiment of the invention, the damping device 173 comprises elastic, mechanical, hydraulic and/or pneumatic damping elements 1731.

In another particular implementation of the first embodiment of the invention, the damping device 173 has a substantially circular cross-section.

This shape contributes to a more uniform distribution of forces, which can be advantageous for the damping function of the damping device 173.

### Second Embodiment of the Invention: a Curved Intermediate Portion

In a second embodiment of the invention, the main body has a front portion, a rear portion and an intermediate portion I.

The front portion includes the front end, the rear portion includes the rear end, while the intermediate portion includes the running gear 120 and connects the front portion to the rear portion.

The intermediate portion comprises at least a first curved-section portion A which has a convexity that is oriented towards the ground.

The term “curved section has a convexity that is oriented towards the ground” refers to a portion of the object that is curved in a specific way. This curvature is such that the most protruding or highest point of the curve, also known as the convexity, is oriented or turned towards the ground.

In a particular implementation, the intermediate portion is exclusively composed of a first curved-section portion A.

Thus, in this particular implementation, the portion of the aircraft tow bar 100 which includes the running gear 120 and which connects the front portion to the rear portion, is entirely formed of a section which has a specific curvature.

This design avoids contact with certain parts of the aircraft that are sensitive to breakage (e.g. a camera).

Finally, the front and rear portions are in a raised position in relation to the intermediate portion.

This means that when the tow bar 100 is resting on the ground, the front and rear ends are higher than the intermediate portion which contains the running gear 120.

### Third Embodiment of the Invention: a Curved Rear Portion

In a third embodiment of the invention, the main body has a front portion and a rear portion.

The front portion includes the front end, while the rear portion includes the rear end and the running gear 120.

In addition, the front portion comprises at least a second curved-section portion B which has a convexity that is oriented towards the ground.

In a particular implementation of the third embodiment of the invention, the second curved-section portion, B, comprises at least one second ground contact element 180 which is designed to move the second curved-section portion, B, over the ground, when it is in contact with the ground.

In one example, the second ground contact element 180 is a wheel or a skid.

In another particular implementation of the third embodiment of the invention, the front portion comprises a first manual handling handle 190 which is disposed in the immediate vicinity of the rear portion, the first manual handling handle 190 being designed to handle the second curved-section portion, B.

The term “manual handling handle” refers to a device designed to facilitate the handling or movement of the second curved-section portion B by a person. This manual handling handle can be gripped by hand to manipulate, move or control the second curved-section portion B.

Thus, when towing an aircraft, an operator o could grip the first manual handling handle 190 to steer the tow bar 100 in order to attach it to the aircraft.

### Fourth Embodiment of the Invention: Attachment Head to the nose landing gear

The fourth embodiment of the invention relates to the configuration where the tow bar 100 is specifically designed to connect to a nose landing gear of an aircraft on the ground.

In the fourth embodiment of the invention, the rear end of the main body comprises a first attachment head C.

The term “attachment head” refers to a part of the tow bar 100 that is designed to connect to the aircraft landing gear.

In practice, the first attachment head C has a cross-section that is generally U-shaped or C-shaped and comprises two longitudinal arms 121 and one transverse arm 121, the free end of each longitudinal arm 121 comprising at least one second manual handling handle 191.

In particular, the second manual handling handles 191 are arranged so as to enable pre-positioning of the first attachment head C relative to a connection point on the nose landing gear.

The term “pre-positioning” refers to the action of placing or positioning something prior to a subsequent action or operation, in this case, attachment to the aircraft. This term can also be interpreted as “pre-centring”.

Here, “pre-centring” means that the second manual handling handles 191 enable approximate centring and rough positioning, of the tow bar 100 relative to the aircraft, before final attachment.

Thus, when the operator handles and orients the tow bar 100 using the second manual handling handles 191, these enable him to easily pre-position and pre-align the end of the tow bar 100 with respect to the attachment point on the aircraft, prior to the final connection.

The second manual handling handles 191 therefore play a pre-centring role, i.e. approximate initial positioning to facilitate the attachment of the tow bar 100 to the aircraft.

### Fifth Embodiment of the Invention: an Attachment Head to the Nose Wheel Strut

The fifth embodiment of the invention relates to a configuration where the tow bar 100 is specifically designed to engage with a nose wheel strut of an aircraft on the ground.

In the fifth embodiment of the invention, the rear end of the main body comprises a second attachment head D.

The second attachment head D comprises a housing 192, a second pivot pin 193 and a second mechanical holding mechanism 194.

In practice, the housing 192 extends transversely through the second attachment head D and, it is in this housing 192 that at least part of the nose wheel strut engages, via an attachment spool of the nose wheel strut.

In addition, the second pivot pin 193 is integral with the second attachment head D and extends transversely through the latter.

Finally, the second mechanical holding mechanism 194 is designed to tilt in rotation about the second pivot pin 193 between an open position and a closed position.

In the open position, the part of the nose wheel strut can enter the housing 192, and the second mechanical holding mechanism is housed substantially entirely in a side wall 1921 of the housing 192.

In the closed position, the second mechanical holding mechanism 194 blocks the exit from the housing 192, thereby locking part of the nose wheel strut inside the housing 192, and the second mechanical holding mechanism 194 is positioned substantially entirely projecting with respect to the side wall 1921 of the housing 192.

In a particular implementation, the second mechanical holding mechanism 194 comprises a second elastic return device that is designed to return the second mechanical holding mechanism 194 to the closed position.

In one example, the second mechanical holding mechanism 194 is a locking latch.

In another particular implementation, the tow bar 100 comprises a second mechanical control mechanism and a second mechanical control transmission mechanism.

In practice, the second mechanical control mechanism is designed to produce an exclusively mechanical force and to be movable between a first position and a second position, by direct transmission of at least one manual translational movement or one manual rotational movement.

In one example, the second mechanical control mechanism is a lever or push button.

In another example, the second mechanical control transmission mechanism is selected from a series of cables, rods, connecting rods, a gear train or any other mechanism capable of transmitting movement between the second control mechanism and the second holding mechanism.

Furthermore, the second mechanical control transmission mechanism is designed to kinematically connect the second mechanical control mechanism and the second mechanical holding mechanism 194.

Other aspects related to the invention are described below.

In a first particular embodiment, the main body of the tow bar is designed able to be dismantled and reassembled in the longitudinal direction.

In practice, the main body of the tow bar is subdivided into at least two longitudinal portions which are designed to be coupled in a manner that can be dismantled and reassembled (for example using nuts and bolts) at one of their respective ends.

The longitudinal portions are designed to nest together.

In this way, the tow bar can be easily stowed, folded-away, in the cargo hold of an aircraft.

In a second particular embodiment, the main body of the tow bar is designed such that it can be folded away and reassembled in the longitudinal direction.

In practice, the main body of the tow bar comprises at least two longitudinal portions, one of which can be folded away and is pivotally connected to the other longitudinal portion. The main body further comprises a hinge connection portion which is formed between the foldable longitudinal portion and the other longitudinal portion.

In addition, the foldable longitudinal portion is designed, when in its folded-away position, to nest together with the other longitudinal portion.

In this way, the tow bar can be easily stowed, folded-away, in the cargo hold of an aircraft.

In a third particular implementation, the damping element comprises a plurality of spacers 1731 which are formed from a material with plastic behaviour (for example rubber or similar material) which are axially separated from one another by at least one retaining element 1732 (for example a thrust washer).

In addition, the retaining elements 1732 which are located at the ends of the damping element are thicker than the intermediate retaining elements 1732, and have a diameter which is greater than the longest side of drawbar 171, of square or rectangular cross-section.

In practice, when the drawbar 171 is installed in the internal volume of the main body of the tow bar, the drawbar 171 is held in place by a first fixed stop, known as the front stop, and a second fixed stop, known as the rear stop, which are disposed along the main body. In this case, the front is considered to be located on the side of the first end of the drawbar and the rear is located on the side of the second end of the drawbar.

The drawbar 171 is guided in its central portion by a guide element (with rectangular cross-section in FIG. 8). This guide element is housed between the main tube and the drawbar, allowing the drawbar to slide precisely in the main tube.

The front stop is disposed in front of one of the end washers of the damping element, known as the front washer. The second stop is disposed after the other end washer of the damping element, known as the rear washer.

In this way, the damping element is blocked in abutment between the front stop and the rear stop.

During use of the tow bar, when the tow bar is pulled (i.e., via the drawbar head), the rear washer will lift off the rear stop and compress the plurality of spacers, which thus damps or eliminates oscillations produced in the longitudinal direction of the tow bar.

Again, during use of the tow bar, when pushing the tow bar (i.e., via the drawbar head), the front washer will lift off the front stop and compress the plurality of spacers, which thus damps or eliminates the oscillations produced in the longitudinal direction of the tow bar.

In a particular implementation of this particular embodiment, the main body and tow bar each have a pinning through-hole perpendicular to the axis of the main body, which coincide when the drawbar is installed within the internal volume of the tow bar main body.

Then, in this particular implementation of this particular embodiment, the tow bar comprises a retaining member (that is for example cylindrical) such as a pin or ball pin. The retaining member is designed to be housed in the coinciding pinning through-holes.

In practice, the retaining member is designed to hold the main body and drawbar together when the retaining member is engaged in the coinciding pinning through-holes, thereby inhibiting the damping element.

Furthermore, the retaining member is designed to allow the main body and drawbar to separate when the retaining member is disengaged from the coinciding pinning through-holes, thereby releasing the damping element.

1. A tow bar specifically designed to connect to a nose landing gear or to engage with a nose wheel strut of an aircraft on the ground, so as to tow or push the aircraft, the tow bar comprising:
a main body which extends longitudinally between a first end for attachment to the aircraft, referred to as the rear end, and a second end for attachment to a towing vehicle, referred to as the front end, the front end being opposite the rear end, the main body having a desired weight,
a first pivot pin integral with the main body and extending transversely through the main body,
a running gear which comprises a pair of arms which are angularly adjustable relative to the main body and which are integrally connected to each other in parallel, each arm having a proximal portion and a distal portion,
each distal portion carrying at least a first ground contact element which is designed for moving the main body over the ground, when it is in contact with the ground,
each proximal portion being coupled to the first pivot pin so as to be freely rotatable thereabout, allowing the running gear to occupy a succession of indexed positions which lie between:
a first extreme position, referred to as the folded-away position, in which the ground contact elements are located at a minimum distance from the main body, and
a second extreme position, referred to as the deployed position, in which the ground contact elements are located at a maximum distance from the main body,
a mechanical device for indexing the position of the running gear comprising:
a first mechanical control mechanism, producing an exclusively mechanical force, which is designed to be movable between a first position and a second position, by direct transmission of at least one manual translational movement or one manual rotational movement,
a first mechanical holding mechanism which comprises a first elastic return device designed to bring the first mechanical holding mechanism to the various indexed positions, the first mechanical holding mechanism being designed, when subjected to the effect of the weight of the main body, to block the various indexed positions so that the arms cannot rotate freely about the first pivot pin,
a first mechanical control transmission mechanism designed to kinematically connect the first mechanical control mechanism and the first mechanical holding mechanism,
wherein, the mechanical indexing device is designed:
in response to manual raising of the front end of the main body, relative to the ground, to at least partially relieve the first mechanical holding mechanism of the effect of the weight of the main body, and subsequently actuating the first mechanical control mechanism,
to transmit the exclusively mechanical force to release the first mechanical holding mechanism, so as to unblock the indexed position so that the arms can rotate freely about the first pivot pin.

2. The tow bar according to claim 1, wherein the first mechanical holding mechanism comprises an indexing finger and a notching designed to cooperate with the indexing finger, the indexed positions succeeding one another in a discrete manner.

3. The tow bar according to claim 2, wherein the notching is formed on a surface of a periphery of at least one of the arms.

4. The tow bar according to claim 1, wherein the running gear is designed to occupy at least a third position, referred to as the partially retracted position, in which the ground contact elements are located at a distance from the main body that is between the minimum distance and the maximum distance.

5. The tow bar according to claim 1, further comprising at least one fixed handle which is disposed on the main body in an immediate vicinity of the first mechanical control mechanism, the fixed handle being designed to be gripped by at least part of an operator's hand, so as to enable the operator to exert a supporting force when actuating the first mechanical control mechanism.

6. The tow bar according to claim 1, wherein at least part of the main body, referred to as the front portion, which includes the front end, has a substantially square or rectangular cross-section, all or part of the front portion being hollow and defining an internal volume which is designed for a shock absorbing drawbar assembly to be housed at least partially therein, the shock absorbing drawbar assembly comprising:
a drawbar,
a fixed stop, and
a damping device, integral with the drawbar in a coaxial manner, which is interposed between the drawbar and the fixed stop to allow horizontal movement so as to damp dynamic stresses.

7. The tow bar according to claim 6, wherein the damping device comprises elastic, mechanical, hydraulic and/or pneumatic damping elements.

8. The tow bar according to claim 6, wherein the damping device has a substantially circular cross-section.

9. The tow bar according to claim 1, wherein the main body has:
a front portion which includes the front end,
a rear portion which includes the rear end, and
an intermediate portion which includes the running gear and which connects the front portion and the rear portion together, the intermediate portion having at least a first curved-section portion, A, with a convexity which is oriented towards the ground, wherein the front portion and the rear portion are in a raised position with respect to the intermediate portion.

10. The tow bar according to claim 1 wherein, the main body has:
a front portion which includes the front end, and
a rear portion which includes the rear end and the running gear, the front portion having at least a second curved-section portion, B, with a convexity which is oriented towards the ground.

11. The tow bar according to claim 10, wherein the second curved-section portion, B, comprises at least one second ground contact element which is designed to move the second curved-section portion, B, on the ground, when it is in contact with the ground.

12. The tow bar according to claim 10, wherein the front portion comprises a first manual handling handle which is disposed in the an immediate vicinity of the rear portion, the first manual handling handle being designed to handle the second curved-section portion, B.

13. The tow bar according to claim 1, wherein when the tow bar is specifically designed to connect to a nose landing gear of an aircraft to the ground, the rear end of the main body comprises a first attachment head, C, which has a section with a cross-section that is generally U-shaped or C-shaped having two longitudinal arms and one transverse arm, the free end of each longitudinal arm comprising at least one second manual handling handle, the second manual handling handles being arranged so as to allow pre-positioning of the first attachment head, C, relative to a connection point on the nose landing gear.

14. The tow bar according to claims 1, wherein when the tow bar is specifically designed to engage with a nose wheel strut of an aircraft on the ground, the rear end of the main body comprises a second attachment head, D, which comprises:
a housing which extends transversely through the second attachment head, D, and in which at least part of the nose wheel strut engages,
a second pivot pin integral with the second attachment head, D, and extending transversely through the second attachment head, D, and
a second mechanical holding mechanism which is designed to tilt in rotation about the second pivot pin between,
an open position allowing the part of the nose wheel strut to enter the housing, and in which the second mechanical holding mechanism is housed substantially entirely in a side wall of the housing, and
a closed position in which the second mechanical holding mechanism blocks the exit from the housing, thereby locking part of the nose wheel strut inside the housing and in which the second mechanical holding mechanism is positioned substantially entirely projecting with respect to the side wall of the housing.
